(19) United States
(12) Patent Application Publication
(10) Pub. No.: US 2015/0262094 A1
(43) Pub. Date: Sep. 17, 2015

(54) AUTOMATICALLY INSTANTIATING AN ORGANIZATIONAL WORKFLOW ACROSS DIFFERENT GEOGRAPHICAL LOCATIONS

(71) Applicant: International Business Machines Corporation, Armonk, NY (US)

(72) Inventors: James R. KOZLOSKI, New Fairfield, CT (US); Neal M. KELLER, Pleasantville, NY (US); Lorraine M. HERGER, Portchester, NY (US); Matthew A. McCARTHY, Holly Springs, NC (US); Clifford A. PICKOVER, Yorktown Heights, NY (US); Andrew P. WYSKIDA, Fishkill, NY (US)

(73) Assignee: INTERNATIONAL BUSINESS MACHINES CORPORATION, Armonk, NY (US)

(21) Appl. No.: 14/206,116

(22) Filed: Mar. 12, 2014

(51) Int. Cl. G06Q 10/06; G06Q 10/08

(52) U.S. Cl. CPC G06Q 10/0633; G06Q 10/087

(57) ABSTRACT

Disclosed is a novel system and method for continual simulation of the optimal deployment of selecting one or more geographic locations for production of a good or service. Synthetic nodes and hypothetical configurations may be introduced into the mapping, or existing nodes removed, and the estimated communication, and thus performance, cost of these changes automatically and continuously calculated. The energy of the resultant composite order embedding algorithm is measured with the addition of one or more collections of instantiated or synthetic test nodes. In a case when the energy of the order embedding algorithm is sufficiently lower in one configuration than another, a decision module (DM) may be used to automatically determine whether the nodes corresponding to the test nodes should be planned.

### BACKGROUND

The present invention generally relates to planning workflow for an enterprise across geographical locations and more specifically to planning workflow across geographical locations for an enterprise by balancing costs, skills, and regulatory requirements at various geographic locations.

The multinational model of the 20th century, in which companies created small versions of themselves in each country, was a response to the trade barriers that existed at the time. This was a successful model because it enabled the company to grow in those markets, understand local customer requirements and cultivate local talent. But it also created redundancy or duplication as each country had its own back-office functions, such as supply, procurement, finance, and human resources.

Often a parent enterprise organization will use an abstraction of a sub-organization's workflow to implement specific instances of the sub-organization. These instances might serve different purposes in different locations. For example an industrial research division of a company might maintain a formal representation of the abstraction of a the research facility's workflow for the purpose of setting up research facilities at various locations in the United States and across the globe. The functions can be located anywhere in the world, based on the right skills and environment, yet individual instances of a research facility may be required to perform certain research duties in certain locations.

The problem of locating the components of this workflow geographically is complex, since components incur different costs depending on 1) where they are located, and 2) the overall distribution of the workflow across the various geographic locations.

### SUMMARY

The presently claimed invention provides a method, and system for creating more efficient workflows across geographic locations. On a smaller scale, a colocation datacenter, might plan an enterprise workflow in terms of utilization of communication bandwidth by continually simulating the optimal deployment of computing resources in a colocation center based on the constraints of bandwidth between computational nodes and the usage statistics of client applications and data. In the case of an entire workflow, however, bandwidth between workflow components constraint the optimal deployment of these components in geographical locations across the U.S. or even the globe.

More particularly, disclosed is a method and system for mapping work flow components represented as a network of nodes into a set of geographical locations using an order embedding algorithm for nonlinear dimensionality reduction, such as, elastic maps, containing the nodes to determine efficient placement.

The energy of the resultant composite from an order embedding algorithm is measured with the addition of one or more collections of instantiated or fictitious test nodes. In a case when the energy of the order embedding algorithm is sufficiently lower in one configuration than another, a decision module (DM) may be used to automatically determine whether the nodes corresponding to the test nodes should be instantiated.

In one example, the presently claimed invention provides a system and method for managing selection of one or more geographic locations for production of a good or service within an organization. The method begins with accessing at least one network representing at least one workflow for production of a good or service within an organization. The workflow includes at least one pair of components available in a plurality of different geographic locations, and at least one expectation link between each pair of components. Each expectation link is associated with an expected required flow of information between each pair of components available in the different geographic locations. Examples of an expectation link include information for at least one of human resources, accounting operations, management, personnel, legal, computational resources, facilities, or a combination thereof.

An iterative loop is begun in which the network is inserted into a data space of an order embedding algorithm for nonlinear dimensionality reduction. Examples of an order embedding algorithm include an elastic map, a Sammon's map, a Kohonen map, or a combination thereof. Next, association linkages are associated between a workflow component and at least one pair of data points in the data space, each association link representing different candidate geographic locations for components, each association link representing cost of instantiation of a component in one candidate geographic location in the order embedding algorithm. A total energy of the order embedding algorithm is computed. For example, the total energy may be computed as a sum of an approximation energy related to the association links and distortion energy of the network.

Based on the total energy being above a settable threshold, i) one or more of the expectation links are re-associated between a previously unassociated pair of components; ii) one or more of the association links to a previously associated pair of the data points in the data space are re-associated between a previously unassociated pair of components; or iii) both. The iterative loop as outlined above in the previous paragraph is repeated. In one example, the re-associating automatically re-associates the association link between a previously unassociated pair of the data points in the data space and a component in response to the re-association resulting in lower total energy.

In one example, at least one additional component is added as part of the workflow in order to evaluate the total energy of the additional component. The total energy calculated is compared before the additional component was added with the total energy calculated after the additional component has been added.

Otherwise in response to the total energy being below a threshold, the component in one candidate geographic location that has been instantiated is selected. The association link between at least one pair of data points in the data space and a component may be updated with a new cost of instantiation.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a map of United State illustrating example locations of an integrated enterprise;

FIG. 2 is a grid of the latitude and longitude positions of the map of the United States in FIG. 1, with abstract network of geographic locations representing organizational workflow along with the bandwidth requirements for each of the example locations of an integrated enterprise;

FIG. 3 is the grid of the latitude and longitude positions of the United States map of FIG. 2, with assignment energies;

FIG. 4 is a flow chart for implementing the inserting of an abstract organizational workflow into a candidate geography with mappings to individual locations; and

FIG. 5 is a block diagram illustrating one example of a computing device or an information processing system for carrying out the steps of the flow chart in FIG. 4.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In order to solve the complex problem, an entity, such as a company, often uses an abstraction of a sub-organization's workflow to implement specific instances of the sub-organization. These instances might serve different purposes in different locations. For example, for the purpose of setting up research facilities at various locations.

The presently claimed invention provides the use of an order embedding algorithm for nonlinear dimensionality reduction, such as, an elastic map, to automatically and conveniently aid in determining “optimal” geographical locations for instantiating components of an organizational work flow, based on certain constraints.

### NON-LIMITING DEFINITIONS

The terminology used herein is for the purpose of describing particular embodiments only and is not intended to be limiting of the invention.

As used herein, the singular forms “a”, “an” and “the” are intended to include the plural forms as well, unless the context clearly indicates otherwise.

The term “association linkages” is an edge in a “network” linking different candidate “geographic locations” to abstract “components”, each association link representing cost of instantiation of a corresponding real-world “component” in one candidate geographic location in the “order embedding algorithm for nonlinear dimensionality reduction.”

The term “component” as used with a “network” is a node or a portion of a node representing a geographic location to provide at least a portion of a good or service in a workflow.

The terms “comprises” and/or “comprising,” when used in this specification, specify the presence of stated features, steps, operations, elements, and/or components, but do not preclude the presence or addition of one or more other features, integers, steps, operations, elements, components, and/or groups thereof.

The term “coupled” as used herein, is defined as “connected,” although not necessarily directly, and not necessarily mechanically. For example two computer systems may be coupled together over the telecommunications network.

The term “data space” as it applies to “order embedding algorithm for nonlinear dimensionality reduction” is a set of vectors in a finite dimensional Euclidean space.

The term “expectation link” as used with a “network” is an edge.

The term “flow of information” is the amount of measurable data communicated between pairs of “components” within a “network.” The information may include information related to human resources, accounting operations, management, personnel, legal, computational resources, facilities, or a combination thereof.

The term “geographic location” is a physical location, such as, a specific latitude and longitude of a real world instantiation of a “component” within a “network.” The physical location may be within a country or across countries. Moreover the geographic location may include an altitude or height of a “component” to account for various floors within the same building. The geographic location may be within a single country or be distributed across various countries.

The term “globally integrated enterprise” was coined in 2006 by Sam Palmisano, the then CEO of IBM Corp, used to denote “a company that fashions its strategy, its management, and its operations in pursuit of a new goal: the integration of production and value delivery worldwide.”

The term “instantiation” is the creating of a specific instance of a real world “component” at a specific “geographic location” within a “data space” of “an order embedding algorithm for nonlinear dimensionality reduction”, in which the “component” did not previously exist at the specific “geographic location”.

The term “network” is a representation, which may be presented pictorially, of the vertices and edges of a graph. The network should not be confused with the network diagram itself because very different layouts in a data space can correspond to the same graph or network topology.

The term “order embedding algorithm for nonlinear dimensionality reduction” is a tool for nonlinear dimensionality reduction including, an elastic map, Sammon's map, Kohonen map, or a combination thereof.

The term “set of nodes” is embedded in the same space as the “data space” is used to represent an “order embedding algorithm.”

The term “workflow” is a plan or description of the logically necessary, partially ordered set of activities required to accomplish providing a good or service. A workflow may be viewed as an (often optimal or near-optimal) realization of the mechanisms required to execute the same plan repeatedly.

### Example of an Integrated Enterprise and Nature of Workflow

Abstraction of a sub-organization workflow generally exposes the underlying “composition of workflow components”. These components can then map to one or more elements of the sub-organization's core competencies. A sub-organization workflow component can support localization requirements, such as legal and regulatory requirements. However, maximizing the business value of this method depends on well-defined IT and business-process standards and best practices. Locating instances of workflow components using an order embedding algorithm for nonlinear dimensionality reduction, enables highly repeatable and predictable implementation, execution, and management of the sub-organization workflows. Workflow components using automated order embedding algorithm procedures can co-locate or disperse based on current resource or business conditions (e.g., conditions concerning infrastructure capacity and business priority). The order embedding algorithm enables optimized placement of many workflow components such as:
business processes, including sales, manufacturing, accounting, and procurement;
resources including, skills of technologists, contractors, vendors, and suppliers; and
business information including financial, business analytics, and marketing), technology capabilities (e.g., business applications, infrastructure, network, security, and mobility).

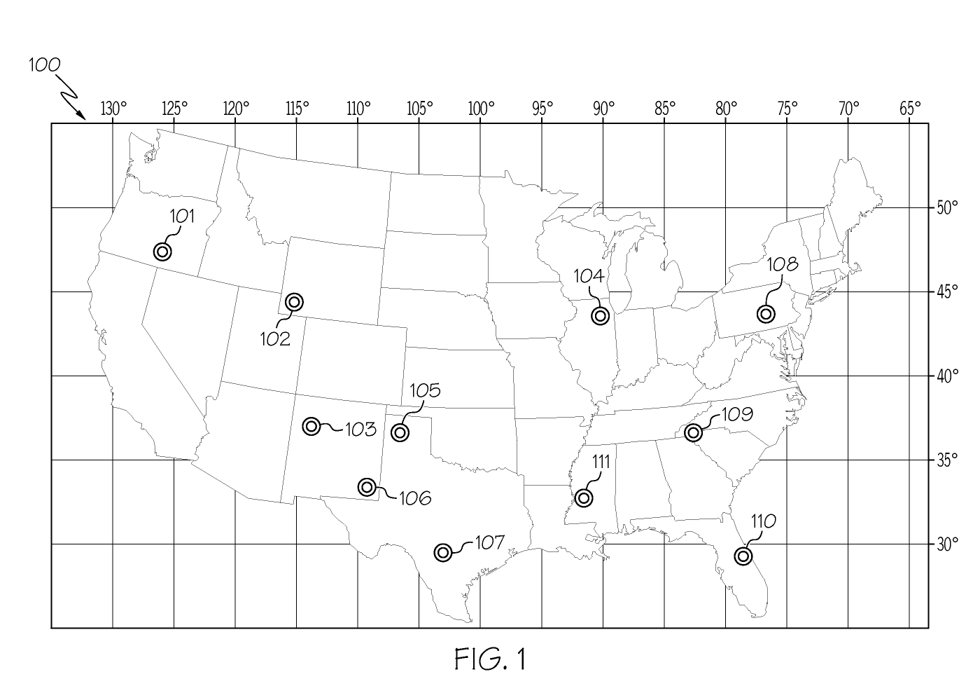

Turning now to FIG. 1, shown is a map 100 of the United States illustrating example locations of an integrated enterprise. In this example, the geographic locations of in Location 1 (101), Location 2 (102), Location 3 (103), Location 4 (104), Location 5 (105), Location 6 (106), Location 7 (107), Location 8 (108), Location 9 (109), Location 10 (110) and Location 111 (111) are shown. Example latitude and longitude lines are also shown to form a geographic coordinate system.

### Instantiation of Components or Test Nodes in a Data Space of an Order Embedding Algorithm

The presently claimed invention, not only uses an order embedding algorithm, but more importantly, makes use of “instantiation” based on certain constraints. The “instantiation” creates a specific instance of a real world component at a specific geographic location within a data space of an order embedding algorithm. The component is a potential or test node because it does not exist at the specific geographic location. Rather, the node in the order embedding algorithm is being hypothetically tested. For example, planners in a corporation use the order embedding algorithm to “plug in” a collection of test nodes. These test nodes or potential nodes may represent geographical locations for instantiating components of an organizational workflow that are not currently in place. Stated differently, a lab is merely hypothetical and not yet operational, or a department is merely hypothetical, partial, or working on other projects, and not yet operational in a new capacity.

Continuing further, the nodes representing departments in a geographical location may actually be automatically suggested if the order embedding algorithm methodology determines that doing so is sufficiently beneficial. For example, these potential nodes may represent a department with different bandwidth or cost characteristics. The bandwidth may be measured in GBPS (Giga Bits Per Second). Costs may include equipment costs, legal costs, bandwidth costs, compliance costs, and more. The energy of the resultant composite order embedding algorithm is measured with the addition of one or more collections of potential nodes, such as, departments. Other real nodes may also be removed.

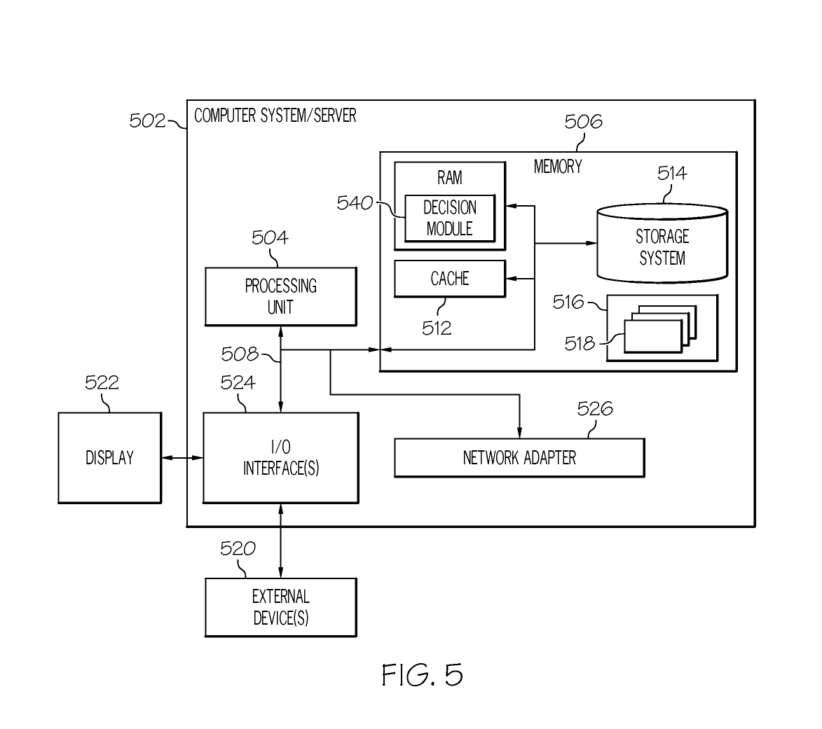

If the energy of the order embedding algorithm is sufficiently lower in one configuration than another, a decision module DM (540 of FIG. 5) may be used to automatically determine whether the nodes corresponding to the test nodes should be instantiated.

### Use of an Automated Map System

The presently claimed invention discloses the convenient and automated use of an order embedding algorithm to determine the geographic location of components of an abstract organizational workflow. For example, a parent organization may wish to instantiate multiple instances of a sub-organization to create different facilities centered at different geographical locations. This may, for example, ensure that certain functions that require intimate knowledge of a growth market are collocated within the geography of that growth market. It may also be done, for example, for reasons of infrastructure capability, and other considerations described herein.

However, the costs of implementing all components of the sub-organization within the geographic location of the growth market may be prohibitive. A good mapping from the requirements of the abstract workflow to the specifics of each candidate geographic location for the instantiation of all workflow components can therefore prove quite valuable to the parent organization.

Since the costs associated with each mapping are highly interdependent, and thus an optimal mapping requires multiple iterations and repricing of these costs, the mapping itself is dynamic as these costs are evaluated. The presently claimed invention updates the geographic mapping of workflow components. The updates are dynamic and use a continually computed order embedding algorithm until a local optimum of costs and workflow implementation details is achieved.

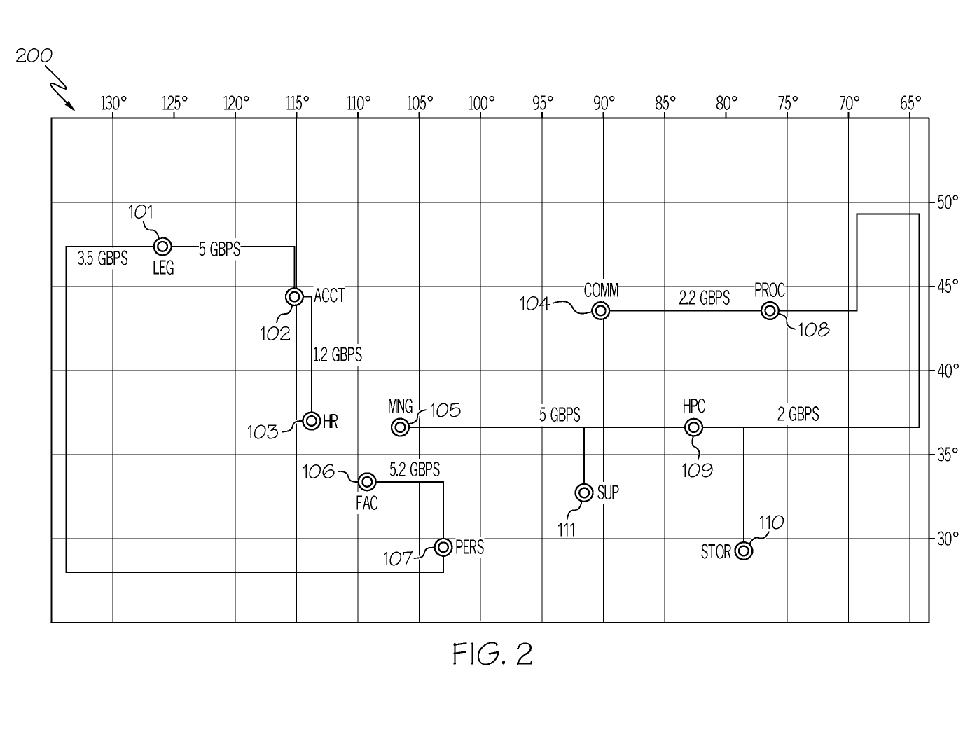

Turning now to FIG. 2, shown is a grid of the latitude and longitude positions of the map of the United States in FIG. 1, with abstract network of geographic locations representing organizational workflow. Also shown in FIG. 2 are the bandwidth requirements for each of the example locations of an integrated enterprise. The example constraints at geographic locations shown are:
LEG—LEGal in Location 1 (101)
ACCT—ACCounting in Location 2 (102)
HR—Human Resources in Location 3 (103)
COMM—COMMunications in Location 4 (104)
MNG—MaNaGement in Location 5 (105)
FAC—FACilities in Location 6 (106)
PERS—PERsonnel in Location 7 (107)
PROC—PROCurement in Location 8 (108)
HPC—High Performance Computing in Location 9 (109)
STOR—STORage in Location 10 (110)
SUP—SUPport in Location 11 (111)

The order embedding algorithm then helps determine how to locate workflow components geographically by first requiring users of the presently claimed invention to construct the abstract network that represents an organizational workflow 200 shown in FIG. 2. Linkages between these components are then associated with bandwidth requirements. Shown are telecommunications communications bandwidth requirements for each of the example geographic locations of an integrated enterprise are shown. These bandwidths may be real computational bandwidths, or may be proxies for the amount of information expected to flow between components by any means, including direct human to human communication.

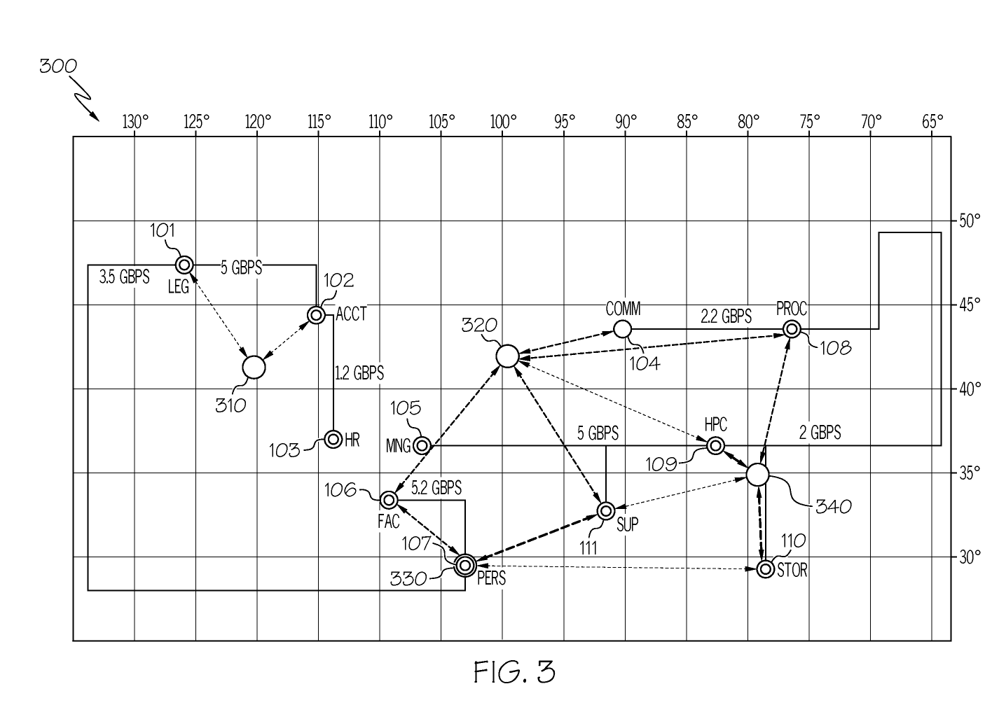

High-bandwidth requirements in the order embedding algorithm then translate into high spring tensions between components of the workflow. FIG. 3 is the grid of the latitude and longitude positions of the map of the United States in FIG. 2, with the highest assignment energies depicted. Note that in the functioning of the normal system other association linkages might exist, with intermediate or low assignment energies, and that all are used during iteration and calculation of system energy. High energies will compete more effectively than low assignment energies for instantiation of workflow components. The high spring tensions between certain components of the workflow in turn ensure these components are co-localized during the mapping. The circles in FIG. 3, at geographic locations 310, 320, 330, and 340 represent instantiations within the data space. Note that latitude and longitude are an arbitrary mapping system that can be re-mapped to X, Y locations in a simple Cartesian grid, without geographical features.

Note that an automated order embedding algorithm may continually compute inter-component bandwidth utilization consumption to optimize both performance and cost. In much the same way, any shared infrastructure resource with inherently limited capacity, such as physical computing resources, for example, CPU, DASD, and RAM, could exploit this capability. Moreover, there may be sub-organization workflow components that are time critical. For example, closing end of year accounting books by a global finance department. Between 30 and 60 days each year, this collection of workflow business processes and applications require the highest possible utilization priority on many shared infrastructure resources.

In one example, the decision module can learn and improve its optimization capability over time by analyzing historical utilization patterns, e.g. over-utilization or under-utilization across shared infrastructure resources, spring tensions, nodes, and placement of workflow components.

The candidate locations for instantiating components of the workflow then define the space into which a network is mapped. In most instances, this space is the same as the geography over which the organization is integrated. These locations do not move during the optimization, since they represent fixed geographical locations and their properties. When two candidate locations for instantiating a workflow component exist, both are assigned association linkages to the workflow component, and each association linkage is associated with a location cost, which in the order embedding algorithm translates to an inversely proportional assignment spring constant as shown in FIG. 3.

By allowing a system of springs to represent the workflow and the geographical embedding, the proximity of components to the geographical locations then is determined by the mapping, in which the system relaxes and the energies are minimized. During each iteration of this optimization, the assignment costs may be updated to reflect the new candidate assignments and their respective costs.

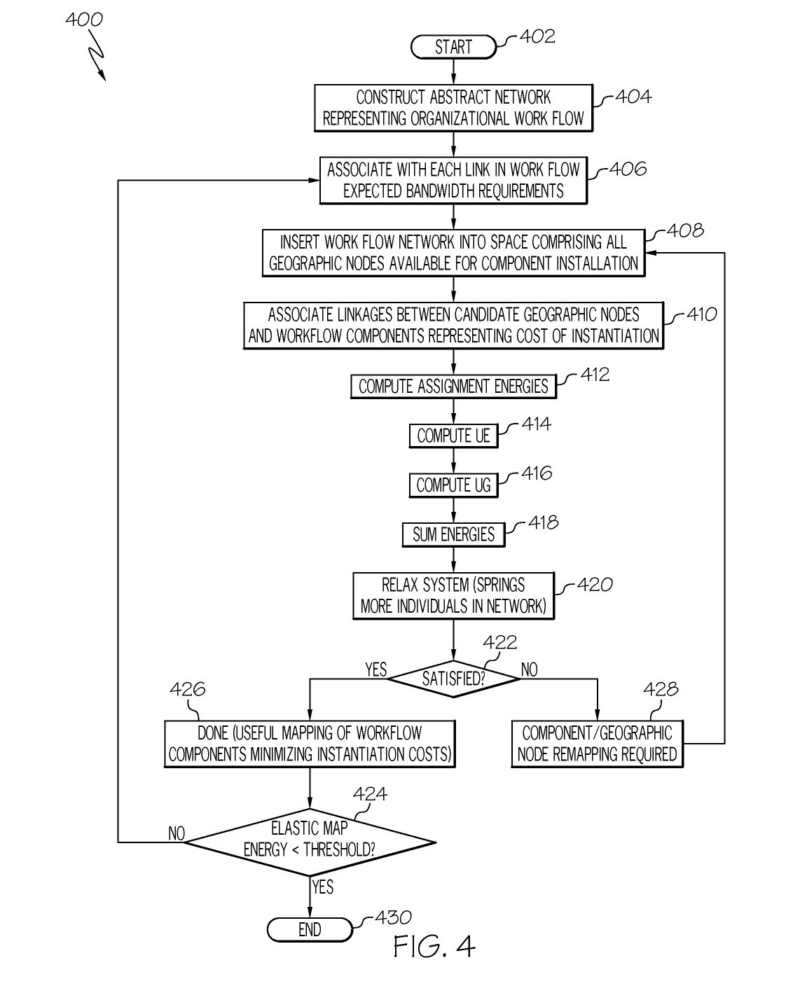

Turning now to FIG. 4, shown is a flow chart 400 for implementing the inserting of an abstract organizational workflow into a candidate geography with mappings to individual locations. The process begins in step 402 and immediately proceeds to step 404 in which an abstraction of an organizational workflow and associated network is constructed. In the example above, FIG. 2 is an example of an organization workflow. FIG. 3 is used to represent bandwidth requirements. Bandwidth requirements refer to the expected required flow of information between various components of an abstracted work flow. Next, in step 406, each expectation link is associated with an expected required flow of information or bandwidth requirement between each pair of components available in the different geographic locations. Information for the expectation link includes information about human resources, accounting operations, management, personnel, legal, computational resources, facilities, or a combination thereof.

In step 408, the network is inserted into a data space with an order embedding algorithm for nonlinear dimensionality reduction. Stated differently, the abstract workflow is embedded into the specific geography and its candidate locations for instantiating components.

In step 410, association linkages are associated between a workflow component and at least one pair of data points in the data space. A cost is assigned to each candidate geographical location for instantiating each component. More specifically, each association link represents: 1) different candidate geographic locations for components; and 2) a cost of instantiation of a component in one candidate geographic location in the order embedding algorithm. The cost of instantiation can include human resources, accounting operations, management, personnel, legal, computational resources, facilities, or a combination thereof. Also the association link may be updated, especially during the iterative runs with an updated cost of instantiation.

Using the order embedding algorithm and the information received, a total energy in step 430 is computed. The total energy, for example, using an elastic map as the ordering embedding algorithm, may be based on computing assignment energies in step 412, the stretching energy U_{E} in step 414, the bending energy U_{G} in step 416, and the sum of the energies in step 418. The system is relaxed in step 420 and a test is made if the constraints are satisfied in step 422. A cost analysis is performed on workflow instantiation and validated against prediction.

In the case in which the constraints are satisfied, a useful mapping results. An interactive loop is entered. A determination is made if the total energy that has been computed is below a settable threshold in step 424. In the case in which the total energy is below a threshold in step 424, the process ends in step 430. Otherwise, in the case in which it is above the threshold, the process repeats to step 406 and changes or updates are made. The updates are re-associating: 1) one or more of the expectation link between a previously unassociated pair of components; and 2) the association link between a previously associated pair of the data points in the data space; or 3) both.

In one example, the re-associating automatically re-associates the association link between a previously unassociated pair of the data points in the data space and a component in response to the re-association resulting in lower total energy. Using the presently claimed invention, “what if” scenarios can be explored. For example, adding at least one additional component as part of the workflow in order to evaluate the total energy of the additional component that has been added, the additional component including at least one additional expectation link associated therewith. A comparison is made of the total energy calculated before the additional component was added with the total energy calculated after the additional component has been added. Otherwise, in the case that the total energy is below a threshold in step 424, the process ends in step 430.

### Potential Nodes and Automated Decision Module

In one example, facilitating automated experimentation, organizational leaders may instantiate or “plug-in” collections of test nodes. These test or potential nodes may actually exist in a partial or standby state. For example a corporation may have rapid access to rented floors of building at a geographical location with certain characteristics, but not yet fully operational. They are made operational and properly staffed and equipped if sufficiently beneficial. In other words, a business organization may “plug in” to the order embedding algorithm a collection of test nodes, and these test or potential nodes may represent nodes that are not currently in full use by a company. In other words, these nodes may be components of an organizational workflow awaiting instantiation. The nodes are automatically enabled and connected if the order embedding algorithm methodology determines that doing so is sufficiently beneficial. These potential nodes may represent components of organizational workflows, for example teams and systems, with different costs and bandwidth characteristics.

As an example, P1 may represent 20 people required in an organizational workflow possessing a particular workflow, skill set, and access to infrastructures with various characteristics. They may also have an estimated cost and bandwidth need to other components in the organization. The association of P1 to a location P2 may represent an instantiation of P1 with an existing set of people, equipment, floors of a building, laboratories in Europe, and more. P1 and P2 may then be “connected” to the elastic map. The energy of the order embedding algorithm is measured of the resultant composite elastic maps after the minimization optimization is performed for each to place workflow in its optimal locations among the nodes. If the energy is sufficiently lower in one configuration than another, a decision module is used to automatically determine whether P1 should be instantiated as P2.

### Task Specific Mapping of Workflow Components

Note that the referenced sub-organizations perform a multitude of tasks. In certain scenarios it may be beneficial to instantiate a somewhat modified mapping of workflow components because a specific task required increased use of High Performance Computing (HPC), increased communication with Human Resources (HR) department, and more. In such scenarios existing alternate nodes providing the same or similar workflow functionality need to exist or to be created quickly for limited periods of time. In such scenarios. it may be advantageous to engage business partners or other third parties to provide node specific services (for a particular period of time) without the need to establish a permanent node. Increased satisfaction and well-being could be one consideration in such computations.

In other scenarios, there may be present certain government or region based restrictions (e.g. government mandated encryption levels) that would prevent the potential location from being considered in the automated Elastic Map system for that specific workflow. The Elastic Map could also use a measure the potential workflow type and map that to a specific region. As an example, consider the research department of a company that may be focused on natural disasters (e.g. hurricane weather) that would have a higher measure in a tropical region allowing for greater access to workflow data and study data availability.

### Costs

Note that costs may relate to any of bandwidth costs, legal costs, compliance costs, video-conference costs, telephony costs, license costs, cost of capital, particularly with regard to import/export costs, and more. Some additional location-specific costs include required language translation for communications with other countries, and the cost associated with frequent communication across multiple time-zones for required communication between organizational locations. Required frequent communication across time-zones is associated with impact on the personal lives of affected employees and may lead to increased stress, poorer performance, and employee turnover or accidents. As an example, workflows that require real-time and interactive collaboration on CAD 3-D graphics may require higher bandwidth than workflows that mostly require email between employees. Increased human-human interaction, satisfaction, and well-being could be one consideration in such computations.

### Information Processing System

Referring now to FIG. 5, this figure is a block diagram illustrating an information processing system or computing device that can be utilized in embodiments of the present invention. The information processing system 502 is based upon a suitably configured processing system configured to implement one or more embodiments of the present invention (e.g., the FIG. 4 process flow). Any suitably configured processing system can be used as the information processing system 502 in embodiments of the present invention. The components of the information processing system 502 can include, but are not limited to, one or more processors or processing units 504, a system memory 506, and a bus 508 that couples various system components including the system memory 506 to the processor 504.

The bus 508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 506 can also include computer system readable media in the form of volatile memory, such as random access memory (RAM) 510 and/or cache memory 512. RAM 510 includes a decision manager 540, such as those shown implemented by flow diagram 400 in FIG. 4.

The information processing system 502 can further include other removable/non-removable, volatile/non-volatile computer system storage media. By way of example only, a storage system 514 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media, or Flash memory, can be provided. In such instances, each can be connected to the bus 508 by one or more data media interfaces. The memory 506 can include at least one program product having a set of program modules that are configured to carry out the functions of an embodiment of the present invention.

Program/utility 516, having a set of program modules 518, may be stored in memory 506 by way of example, and not limitation, as well as an operating system, one or more application programs, other program modules, and program data. Each of the operating system, one or more application programs, other program modules, and program data or some combination thereof, may also include an implementation of a networking environment. Program modules 518 generally carry out the functions and/or methodologies of embodiments of the present invention.

The information processing system 502 can also communicate with one or more external devices 520 such as a keyboard, a pointing device, a display 522, etc.; one or more devices that enable a user to interact with the information processing system 502; and/or any devices (e.g., network card, modem, etc.) that enable computer system/server 502 to communicate with one or more other computing devices. Such communication can occur via I/O interfaces 524. Still yet, the information processing system 502 can communicate with one or more networks such as a local area network (LAN), a general wide area network (WAN), and/or a public network (e.g., the Internet) via network adapter 526. As depicted, the network adapter 526 communicates with the other components of information processing system 502 via the bus 508. Other hardware and/or software components can also be used in conjunction with the information processing system 502. Examples include, but are not limited to: microcode, device drivers, redundant processing units, external disk drive arrays, RAID systems, tape drives, and data archival storage systems.

### NON-LIMITING EXAMPLES

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing selection of one or more geographic locations for production of a good or service within an organization, the method comprising:
a) accessing at least one network representing at least one workflow for production of a good or service within an organization, the workflow including at least one pair of components available in a plurality of different geographic locations, and at least one expectation link between each pair of components;
b) associating with each expectation link an expected required flow of information between each pair of components available in the different geographic locations;
c) inserting the network into a data space of an order embedding algorithm for nonlinear dimensionality reduction;
d) associating association linkages between a workflow component and at least one pair of data points in the data space, each association link representing different candidate geographic locations for components, each association link representing cost of instantiation of a component in one candidate geographic location in the order embedding algorithm; and
e) computing a total energy of the order embedding algorithm.

2. The method of claim 1, further comprising:
f) based on the total energy being above a settable threshold, re-associating one or more of
the expectation link between a previously unassociated pair of components,
the data points in the data space, or
both, and
repeating steps c though e.

3. The method of claim 1, wherein the associating an association link between at least one pair of data points in the data space and a component, includes an association link representing an updated cost of instantiation.

4. The method of claim 1, wherein the order embedding algorithm is an elastic map, Sammon's map, Kohonen map, or a combination thereof.

5. The method of claim 1, wherein the associating with each expectation link an expected required flow of information between each pair of components available in the different geographic locations includes information for human resources, accounting operations, management, personnel, legal, computational resources, facilities, or a combination thereof.

6. The method of claim 1, wherein the associating the association links representing cost of instantiation of a node in one candidate geographic location in the order embedding algorithm includes costs for the one candidate geographic location of human resources, accounting operations, management, personnel, legal, computational resources, facilities, or a combination thereof.

7. The method of claim 2, wherein the re-associating, automatically re-associates the association link between a previously unassociated pair of the data points in the data space and a component in response to the re-association resulting in lower total energy.

8. The method of claim 1, wherein the total energy is computed as a sum of an approximation energy related to the association links and a distortion energy of the network related to the expectation links.

9. The method of claim 8, wherein the order embedding algorithm is an elastic map and the distortion energy of the network is a combination of a stretching energy (U_{E}) and bending energy (U_{G}).

10. The method of claim 1, further comprising adding at least one additional component as part of the workflow in order to evaluate the total energy of the additional component that has been added, the additional component including at least one additional expectation link associated therewith; and
comparing the total energy calculated before the additional component was added with the total energy calculated after the additional component has been added.

11. A computing device for managing selection of one or more geographic locations for production of a good or service within an organization, the computing device comprising:
a memory;
a processor communicatively coupled to the memory, where the processor is configured to perform
a) accessing at least one network representing at least one workflow for production of a good or service within an organization, the workflow including at least one pair of components available in a plurality of different geographic locations, and at least one expectation link between each pair of components;
b) associating with each expectation link an expected required flow of information between each pair of components available in the different geographic locations;
c) inserting the network into a data space of an order embedding algorithm for nonlinear dimensionality reduction;
d) associating association linkages between a workflow component and at least one pair of data points in the data space, each association link representing different candidate geographic locations for components, each association link representing cost of instantiation of a component in one candidate geographic location in the order embedding algorithm; and
e) computing a total energy of the order embedding algorithm.

12. The computing device of claim 11, further comprising:
f) based on the total energy being above a settable threshold, re-associating one or more of
the expectation link between a previously unassociated pair of components,
the association link between a previously associated pair of the data points in the data space, or
both, and
repeating steps c though e.

13. The computing device of claim 11, wherein the associating an association link between at least one pair of data points in the data space and a component, includes an association link representing an updated cost of instantiation.

14. The computing device of claim 11, wherein the order embedding algorithm is an elastic map, Sammon's map, Kohonen map, or a combination thereof.

15. The computing device of claim 11, wherein the associating with each expectation link an expected required flow of information between each pair of components available in the different geographic locations includes information for human resources, accounting operations, management, personnel, legal, computational resources, facilities, or a combination thereof.

16. The computing device of claim 11, wherein the associating the association links representing cost of instantiation of a node in one candidate geographic location in the order embedding algorithm includes costs for the one candidate geographic location of human resources, accounting operations, management, personnel, legal, computational resources, facilities, or a combination thereof.

17. A non-transitory computer program product for managing selection of one or more geographic locations for production of a good or service within an organization, the computer program product comprising a computer readable storage medium having computer readable program code embodied therewith, the computer readable program code configured to:
a) accessing at least one network representing at least one workflow for production of a good or service within an organization, the workflow including at least one pair of components available in a plurality of different geographic locations, and at least one expectation link between each pair of components;
b) associating with each expectation link an expected required flow of information between each pair of components available in the different geographic locations;
c) inserting the network into a data space of an order embedding algorithm for nonlinear dimensionality reduction;
d) associating association linkages between a workflow component and at least one pair of data points in the data space, each association link representing different candidate geographic locations for components, each association link representing cost of instantiation of a component in one candidate geographic location in the order embedding algorithm; and
e) computing a total energy of the order embedding algorithm,

18. The non-transitory computer program product of claim 17, further comprising:
f) based on the total energy being above a settable threshold, re-associating one or more of
the expectation link between a previously unassociated pair of components,
the association link between a previously associated pair of the data points in the data space, or
both, and
repeating steps c though e.

19. The non-transitory computer program product of claim 17, wherein the associating an association link between at least one pair of data points in the data space and a component, includes an association link representing an updated cost of instantiation.

20. The non-transitory computer program product of claim 17, wherein the order embedding algorithm is an elastic map, Sammon's map, Kohonen map, or a combination thereof.
